(19) United States
(12) Patent Application Publication
(10) Pub. No.: US 2012/0319413 A1
(43) Pub. Date: Dec. 20, 2012

(54) CRASH BOX ARRANGEMENT AND METHOD OF DETECTING THE INTENSITY OF AN IMPACT

(75) Inventors: Thorsten Andres, Paderborn (DE); Torsten Gröning, Paderborn (DE); Bjoerg Haupt, Regensburg (DE); Tobias Tyroller, Regensburg (DE)

(73) Assignee: Benteler Automobiltechnik GmbH, Paderborn (DE)

(21) Appl. No.: 13/324,277

(22) Filed: Dec. 13, 2011

(30) Foreign Application Priority Data
Dec. 14, 2010 (DE) 10 2010 054 506.6

(51) Int. Cl. B60R 19/34

(52) U.S. Cl. 293/133

(57) ABSTRACT

A crash box arrangement includes a hollow member having a first hardness and defining a hollow space in communication with at least one ventilation opening; and a damper having a second hardness which is smaller than the first hardness. The damper has an impulse cavity in communication with the hollow space of the hollow member.

### CROSS-REFERENCES TO RELATED APPLICATIONS

This application claims the priority of German Patent Application, Serial No. 10 2010 054 506.6, filed Dec. 14, 2010, pursuant to 35 U.S.C. 119(a)-(d), the content of which is incorporated herein by reference in its entirety as if fully set forth herein.

### BACKGROUND OF THE INVENTION

The present invention relates to a crash box arrangement and method of detecting the intensity of an impact.

The following discussion of related art is provided to assist the reader in understanding the advantages of the invention, and is not to be construed as an admission that this related art is prior art to this invention.

Motor vehicles, in particular passenger cars, have crossbeams across the front and rear to conduct impact energy in a desired manner in the event of an impact or a collision. Crash boxes are normally coupled to the crossbeams and undergo a deformation to compensate the crash energy absorbed by the crossbeams so as to reduce the intensity of the impact and/or to minimize deformation of the vehicle frame. Especially with respect to repair work, this is beneficial in the event of rear-end collisions in a speed range of about ten to fifty kilometers per hour.

The automobile industry, in particular the construction of passenger cars, is increasingly faced with greater demands with respect to safety, especially protection of pedestrians. Various passive or active protections are available to enhance the pedestrian protection in the event of a collision with a motor vehicle. For example, regulations require a generally higher radiator front so that a pedestrian is dragged by the motor vehicle in the event of a collision and is prevented from hitting the windshield with the head. As a consequence of the higher radiator front, the upper body and the head of the pedestrian are caused to impact primarily the hood. The provision of complex front protection bars, as known for example from off-road vehicles, has been prohibited in the meantime.

To further improve safety of pedestrians, some vehicles are equipped with active safety devices. For example, the hood is positioned in close proximity to the subjacent engine block to realize a vehicle structure, in particular a hood that is as flat as possible. In the event of a collision with a pedestrian, the pedestrian would then basically impact the rigid engine block, risking major or even fatal injuries. In order to better protect the pedestrian and provide a more forgiving hood, some motor vehicles have hoods which are lifted actively in the event of a collision with a pedestrian so as to provide the hood with enough crumpling space until the pedestrian's torso or head impacts the engine block arranged underneath.

A further protective measure for pedestrian protection involves in particular the provision of yielding front and rear shields and the optional presence of a dampening yielding material there behind. The front shields but also the rear shields can be manufactured from flexible plastics and behind the shields elastomer or foam material can be placed to further reduce impact intensity, especially for pedestrians.

A further approach involves motor vehicles equipped with ever more complex pre-crash sensor mechanism and/or pre-crash devices to further enhance the protection of occupants in a motor vehicle. It is known, for example, to use crash boxes which actively move out to provide added deformation space in the event of an impact.

Common to all active protective devices for pedestrian protection or protection of occupants is the need for various sensors so as to ensure that the active safety system is triggered in a timely, failsafe, reliable and lasting fashion. It is hereby desired to not make the sensor systems for motor vehicles too complicated and to exploit synergistic effects so that an acceleration sensor of an electronic stability program can also be used for a pre-crash sensor mechanism for example.

It would be desirable and advantageous to obviate prior art shortcomings.

### SUMMARY OF THE INVENTION

According to one aspect of the present invention, a crash box arrangement includes a hollow member having a first hardness and defining a hollow space in communication with at least one ventilation opening, and a damper having a second hardness which is smaller than the first hardness, the damper having an impulse cavity in communication with the hollow space of the hollow member.

According to another advantageous feature of the present invention, the damper can be made of elastomer and/or foam material.

According to another advantageous feature of the present invention, an adapter plate may be provided for closing the hollow space of the hollow member. Advantageously, a pressure sensor can be arranged on the adapter plate so as to be positioned either in or at the hollow space and thereby monitor the interior of the hollow member. The damper can be coupled to the hollow member. In the event of an impact as a result of a collision or crash, the damper and/or hollow member deform to cause a pressure increase in the interior space. Gas, e.g. ambient air, is compressed by the pressure increase and can escape through the ventilation opening. Closing the hollow space of the hollow member by the adapter plate and attachment of the pressure sensor for example onto the adapter plate enhances producibility.

The ventilation opening may simply be realized as a bore or hole. It is, of course, also conceivable to provide the ventilation opening with a valve or a seal which is activated when a predefined pressure state is reached.

The damper has an impulse cavity which may involve a hollow space within the damper that can be used for further signal transmission. The impulse cavity may be formed partly or entirely within the damper. When being incorporated entirely within the damper, the impulse cavity can be configured as a hollow space extending longitudinally through the damper, e.g. in the form of a hole which extends end-to-end. The longitudinal direction of the damper is hereby defined by the impact direction that is most likely to occur. In the event of an impact, a pressure impulse is generated in the impulse cavity at slightest compressions in longitudinal direction when the impulse cavity extends entirely or at least along a major portion through the damper.

The impulse cavity communicates with the hollow space of the hollow member. The pressure impulse signal generated in the impulse cavity is thus able to propagate into the hollow space. Essentially all air in the impulse cavity and the hollow space is compressed. The pressure impulse escapes through the ventilation opening. The various pressure changes and/or pressure change speeds are detected by the pressure sensor itself.

The damper is provided in the crash box arrangement according to the present invention in particular for pedestrian protection or for protection in the event of rear-end accidents of up to max. 15 km/h, especially max. 10 km/h. In the event of a collision of a pedestrian or small animal with a motor vehicle at low speed, the elastic property of the damper can be utilized to dampen the impact energy. As a result, any injury to a pedestrian, for example in the knee or leg region is minor as opposed to a situation when hitting a rigid object. A front shield of flexible plastic placed anteriorly of the damper is also yielding to dampen and disperse impact energy across a greater surface.

According to another advantageous feature of the present invention, the ventilation opening can be formed in the adapter plate. This allows production of a crash box in a conventional manner as an extrusion profile or also tubular profile and use of the crash box to define in conjunction with the adapter plate the hollow space in a cost-efficient manner.

The adapter plate can undergo complex manufacturing steps or mounting steps. This may involve, for example, the bore or geometric configuration of the ventilation opening and/or attachment of the pressure sensor. The crash box arrangement according to the present invention can easily be maintained, replaced or repaired in the event the pressure sensor malfunctions or the ventilation opening is defective. Advantageously, the adapter plate is arranged between the crash box arrangement and side rails to which the crash box arrangement is mounted.

According to another advantageous feature of the present invention, a cover may be coupled to the damper. The cover may be configured in the form of a sleeve which embraces at least some areas of the damper. It is also conceivable that the cover simply covers only an end face of the damper. When the impulse cavity extends end-to-end, the cover closes the impulse cavity of the damper and disperses simultaneously an impact force, generated by an impact, across the entire cross sectional area of the damper. A deflection of the damper can be prevented when the cover is configured in the form of a sleeve-like ensheathing of the damper.

According to another advantageous feature of the present invention, the cover and the hollow member can be movable in relation to one another to form a crash box. The crash box may hereby be configured in a telescoping manner. The cover and the hollow member are able to realize various stages of energy dissipation of the crash box. For example, in the event of a collision, it is the cover or the hollow member that may first crumple so that crash energy is converted into deformation energy and dissipated. When the impact is more intense, both cover and hollow member may crumple at the same time or may push into one another and then crumple after being pushed together.

According to another advantageous feature of the present invention, the geometric configuration of the ventilation opening and/or size of the ventilation opening can be configured in dependence on the change in pressure detected by the pressure sensor. As a result, the pressure sensor can be used to measure the pressure intensity and/or speeds by which the pressure changes.

A crash box arrangement according to the present invention for detecting a collision with a pedestrian or with another vehicle can be optimized depending on the weighting of the two different measuring processes. When detecting an impact with a pedestrian, the emphasis of the measuring process is on mass discrimination so as to establish a relatively small opening of the ventilation opening. When detecting a collision with another vehicle, the emphasis lies on a detection of the pressure change so that a relatively large ventilation opening is selected. It is therefore possible within the scope of the present invention to install two sensors to generate two measuring signals, with one sensor being optimized for detection of a collision with a pedestrian, and the other sensor being optimized for detection of a collision with another vehicle.

According to another aspect of the present invention, a method of detecting the intensity of an impact includes generating a pressure signal in response to a deformation of a damper of a crash box in the event of an impact for transmission to a hollow space of a hollow member of the crash box, allowing pressure to escape the hollow space through a ventilation opening in communication with the hollow space, and detecting an intrusion intensity and/or intrusion speed in response to the impact.

To ensure clarity, it is necessary to establish the definition of several important terms and expressions that will be used throughout this disclosure. The term “intrusion intensity” relates to a pressure change within the hollow space. The term “intrusion speed” relates to a pressure speed change as a function of time.

While the steps of generating the pressure signal and allowing the pressure to escape may occur simultaneously or sequentially, detection of the intrusion intensity and/or the intrusion speed occurs either during or after the afore-described steps. When intrusion intensity is detected, it is possible to react in an especially sensitive manner to collisions with minimal pressure impulse. For example, when colliding with a pedestrian, a signal can be transmitted to a controller to trigger respective safety measures in the vehicle to protect vehicle occupants and the pedestrian. In concrete terms, this can involve for example activation to actively lift the engine hood so as to dampen an impact of a pedestrian upon the vehicle front as best as possible in order to minimize risk of injury.

A method according to the present invention is also able to distinguish between an impact at slight intensity and an impact at high intensity. In the event of an impact at high intensity, for example a frontal crash of vehicles, the activation of a safety element, such as for example an active hood, can have an adverse effect for the occupants of the vehicle. Therefore, it may be better to keep the engine hood in its original position in order to enable the sensor to detect various accident scenarios in a rapid, reliable and lasting manner and to transmit respective control signals. In particular, when an impact at high intensity is involved, e.g. rear-end collisions or frontal crashes, the impact is detected using the intrusion speed. In the event of an impact at slight intensity, e.g. collision with a pedestrian, the impact is detected by a pressure senor, using the intrusion intensity of gas compressed in the hollow space and in the impulse cavity.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is an exploded view of a crash box arrangement according to the present invention;

FIG. 2 is a schematic illustration of the crash box arrangement undergoing various stages during an impact; and

FIG. 3 is a perspective illustration of an adapter plate.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

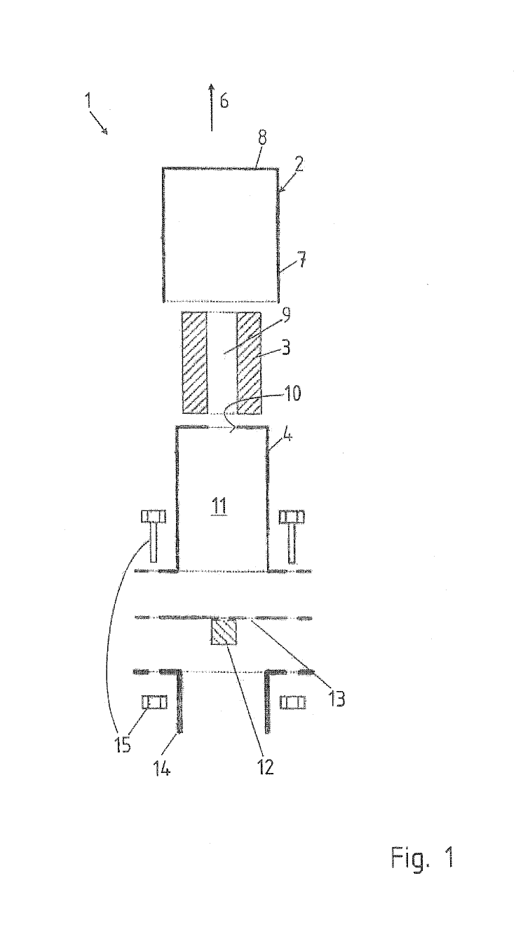

Turning now to the drawing, and in particular to FIG. 1, there is shown an exploded view of a crash box arrangement according to the present invention, generally designated by reference numeral 1. The crash box arrangement 1 has a sleeve-like cover 2, a damper 3, a hollow member 4 having a hollow space 11, and an adapter plate 5, arranged behind one another in a longitudinal direction, as indicated by arrow 6. The cover 2 has a sleeve portion about its circumference and a cover plate 8 atop of the cover 2. The cover plate 8 also closes the open top of the damper 3.

The hollow member 4 is made of material of a hardness which is greater than a material used for making the damper 3. The material for the hollow member 4 and also for the cover 2 includes metallic materials, such as steel or light metal, e.g. aluminum, or fiber composites made of carbon fiber or glass fibers for example. The damper 3 can be made of elastomer and/or foam material.

The damper 3 has an impulse cavity 9 which extends in the non-limiting example shown here in longitudinal direction 6 of the damper 3 from end to end. The impulse cavity 9 is in communication with the hollow space 11 of the hollow member 4 via a coupling opening 10 of the hollow member 4. Arranged on the side of the hollow member 4 in opposition to the coupling opening 10 is the adapter plate 5 to close the hollow member 4. A pressure sensor 12 is arranged on the adapter plate 5 which is formed with a ventilation opening 13. When assembling the crash box arrangement, the diameter of the ventilation opening 13 is sized to either put the focus on a measurement of the intrusion intensity or the intrusion speed. In other words, the detection focuses either on pedestrian protection or crash detection with other vehicles, whereby the pedestrian protection relates to the intrusion intensity so that the diameter of the ventilation opening 13 is smaller compared to the diameter of the ventilation opening 13, when the measurement of intrusion speed is involved to focus on a crash situation of greater intensity.

The crash box arrangement 1 is linked via the adapter plate 5 with a vehicle side rail 14, shown here only schematically, by a bolted connection 15 for example.

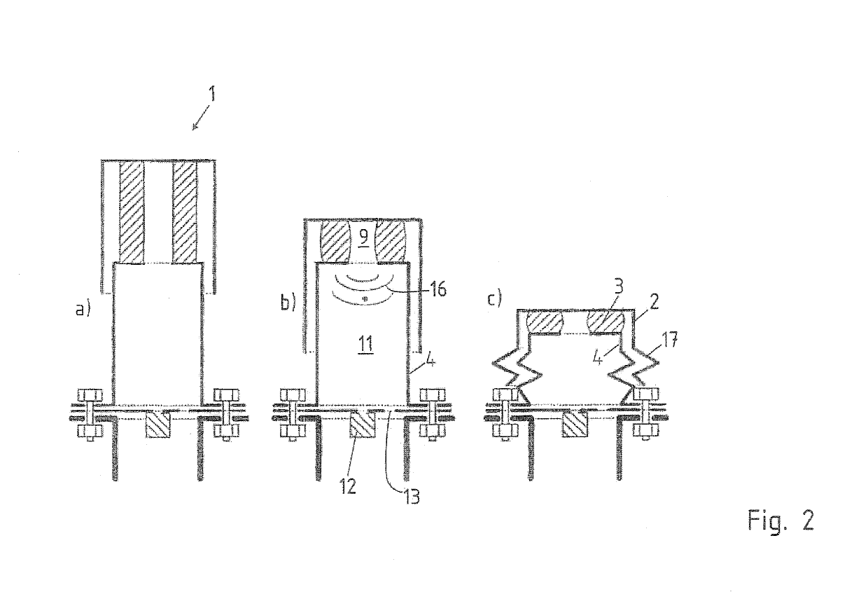

FIG. 2 shows the crumpling behavior of the crash box arrangement 1 in the event of an impact. FIG. 2a shows a cross section of the crash box arrangement 1 in an assembled state. In the event of an impact at low intensity, for example a collision of the vehicle with a pedestrian, the damper 3 is compressed, as shown in FIG. 2b. The compression of the damper 3 generates a pressure wave 16 in the impulse cavity 9 which is able to propagate into the hollow space 11 of the hollow member 4. The pressure wave 16 escapes through the ventilation opening 13 and is detected by the pressure sensor 12 which sends a signal to a controller to trigger a safety mechanism which is integrated in the vehicle in order to protect vehicle occupants and the pedestrian. A conceivable safety mechanism is for example a lift device for an active hood, as described in U.S. Pat. No. 7,931,111 to Kim et al. and U.S. Pat. No. 7,303,040 to Green et al., to which reference is made herewith.

FIG. 2c illustrates an impact at high intensity, which causes the damper 3 to fully compress. The cover 2 is shifted in the direction of the hollow member 4 and is pushed entirely over the hollow member 4. As a result, the damper 3 and the hollow member 4 crumple as indicated by reference numeral 17 to generate deformation work, thereby minimizing the impact intensity of the crash. Appropriate safety measures may hereby be triggered for deployment of airbags or belt tensioners for example, through use of e.g. acceleration sensors.

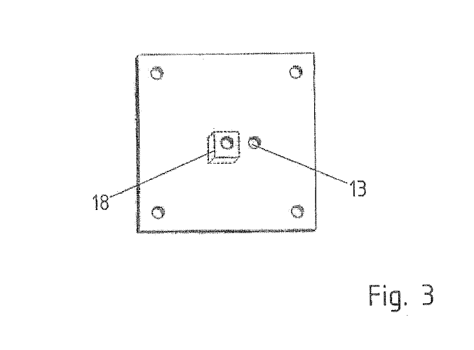

FIG. 3 shows a perspective view of the adapter plate 5 with the ventilation opening 13 and a holder 18 for the pressure sensor, not shown here.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A crash box arrangement, comprising:
a hollow member having a first hardness and defining a hollow space in communication with at least one ventilation opening; and
a damper having a second hardness which is smaller than the first hardness, said damper having an impulse cavity in communication with the hollow space of the hollow member.

2. The crash box arrangement of claim 1, wherein the damper is made of a material selected from the group consisting of elastomer, foam material, and a combination of both.

3. The crash box arrangement of claim 1, further comprising an adapter plate for closing the hollow space of the hollow member.

4. The crash box arrangement of claim 3, further comprising a pressure sensor arranged on the adapter plate.

5. The crash box arrangement of claim 3, wherein the ventilation opening is formed in the adapter plate.

6. The crash box arrangement of claim 1, further comprising a cover coupled to the damper.

7. The crash box arrangement of claim 6, wherein the cover and the hollow member are movable in relation to one another to form a crash box.

8. The crash box arrangement of claim 1, further comprising a pressure sensor to detect a pressure change in the hollow space, wherein the ventilation opening has a geometric configuration and/or size in dependence on the pressure change detected by the pressure sensor.

9. A method of detecting the intensity of an impact, comprising:
generating a pressure signal in response to a deformation of a damper of a crash box in the event of an impact for transmission to a hollow space of a hollow member of the crash box;
allowing pressure to escape the hollow space through a ventilation opening in communication with the hollow space; and
detecting an intrusion intensity and/or intrusion speed in response to the impact.

10. The method of claim 9, further comprising detecting an impact of high intensity as a function of the intrusion speed.

11. The method of claim 9, further comprising detecting an impact of low intensity as a function of the intrusion intensity.
